(19) United States
(12) Patent Application Publication
(10) Pub. No.: US 2010/0136959 A1
(43) Pub. Date: Jun. 3, 2010

(54) DOCUMENT DELIVERY SYSTEM OF GSM MOBILE SUPPORTING MIDP ENVIRONMENTS AND THEREOF

(76) Inventor: Jong Chul Kim, Seoul (KR)

Correspondence Address: CHRISTIE, PARKER & HALE, LLP, PO BOX 7068, PASADENA, CA, 91109-7068, US

(21) Appl. No.: 12/598,415

(22) PCT Filed: Apr. 30, 2007
(86) PCT No.: PCT/KR07/02115

§ 371 Date: Oct. 30, 2009

(51) Int. Cl. H04L 29/08

(52) U.S. Cl. 455/414.4

(57) ABSTRACT

The present invention relates to a GSM mobile document transfer system for supporting MIDP environments and a transferring method thereof, in that a MS office document or another office document are transferred to a mobile communication terminal through a web to phone manner, whereby it can receive and view the office and image documents in general GSM mobile communication terminal at any time without installing a separating document viewer beforehand. Accordingly, the documents can be received through the GSM mobile communication terminals for supporting MIDP environments at any time, so that it can view the document in the unspecific GSM mobile communication terminals for supporting MIDP environments without installing separating view programs. Also, the documents can be received through all of the GSM mobile communication terminals, so that various office, image and fax documents, which are transferred by only an E-mail in the prior art, can be directly transmitted to the receiver mobile communication terminal, whereby the user can send and receive the desired document without restrictions on time and place.

### TECHNICAL FIELD

The present invention relates to a GSM mobile document transfer system for supporting MIDP environments and a transferring method thereof, and more particularly to a GSM mobile document transfer system for supporting MIDP environments and a transferring method thereof, in that a MS office document or another office document are transferred to a mobile communication terminal through a web to phone manner, whereby it can receive and view the office and image documents in general GSM mobile communication terminal at any time without installing a separating document viewer beforehand.

### BACKGROUND ART

Recently, a demand capable of inquiring and utilizing a document under various surroundings has been increased according to the issue of “Ubiquitous”. Also, a cell phone with a file viewer capable of viewing the document in a mobile communication terminal has been released.

However, in order to inquire the document in the receiver mobile communication terminal at present, it is necessary to connect a computer terminal with the receiver mobile communication terminal through a connecting cable such as an USB port and like and transmit the data of the computer terminal to the receiver mobile communication terminal. Accordingly, there are restrictive and inconvenient in use. That is, since the receiver mobile communication terminal has a small capacity in memory, there is a limit in memory capacity that the document itself of the computer terminal cannot be transmitted to the receiver mobile communication terminal through an internet. Also, an application capable of inquiring the document is not installed in all mobile communication terminals.

Also, as though the file viewer is installed in the receiver mobile communication terminals, the document can be viewed through the receiver mobile communication terminal only in case of connecting the computer terminal with the receiver mobile communication terminal through the connecting cable. The file viewer of the receiver mobile communication terminals can be applied to only MS-office document, not all document formats.

Moreover, since the receiver mobile communication terminal does not have all kinds of fonts existed in PC environments, it is impossible to view in the shape of the font equally with the original document.

Therefore, a mobile document transfer system capable of improving the document inquiry environment in the restricted mobile communication terminal and transmitting and receiving the desired document anytime and anywhere without correlation to the corresponding document format file has been required. Also, a mobile document transfer means using unspecific GSM mobile communication terminals for supporting MIDP environments has been also required.

### DISCLOSURE OF INVENTION

### Technical Problem

Accordingly, the present invention has been made to solve the above-mentioned problems occurring in the prior art, and an object of the present invention is to provide a GSM mobile document transfer system for supporting MIDP environments and a transferring method thereof, in that the documents written with various document writing program are converted into a merging document format file having a font capable of viewing the document format file in a GSM mobile communication terminal for supporting MIDP environments and URL information stored in the corresponding document is transmitted to the GSM mobile communication terminal, whereby it can check out the corresponding document in the receiver mobile communication terminal having limited resources through the converted document and mobile communication terminal viewer without installing various word processing programs.

Another object of the present invention is to provide a GSM mobile document transfer system for supporting MIDP environments and a transferring method thereof, in that a converted merging document format file is merged with a view file so as to generate a document embedding viewer, whereby it can directly view the document through the transferred document embedding viewer simultaneously with the connection with the receiver mobile communication terminal without installing a separating document embedding viewer beforehand.

Further another object of the present invention is to provide a GSM mobile document transfer system for supporting MIDP environments and a transferring method thereof, in that partial front pages of a document are merged with a view file so as to generate a document embedding viewer and the URL of the remaining portion of the document is assigned to the view file in a case that the file size of the document is very larger, whereby it can receive and view additional document during additional reading of corresponding page.

### Technical Solution

To accomplish the objects, the present invention provides a GSM mobile document transfer system for supporting MIDP environments comprising: a user terminal for writing a document with various document writing program and saving it and connecting to a mobile document receiving server through an internet; the mobile document transmitting server for receiving an original document made by the user terminal and a receiver information, converting the document into a merging document format file having a font capable of viewing the document format file in the receiver mobile communication terminal, generating a document embedding viewer by merging the converted merging document format file with a view file, saving the document embedding viewer, and transmitting a message including an URL (uniform resource locator) to the receiver mobile communication terminal so as to download the document embedding viewer having the merging document format file; and the receiver mobile communication terminal for receiving the message having the URL from the mobile document transmitting server, connecting to the URL in order to receive the corresponding document embedding file and displaying it to a receiver.

According to the GSM mobile document transfer system for supporting MIDP environments, the mobile document transmitting server comprises: a document receiving portion for receiving an original document made by the user terminal and a receiver information; a document format conversion portion for receiving the document and converting the document into a merging document format file having a font capable of viewing the original document in the receiver mobile communication terminal; a view file generating portion for generating a view file in order to view the merging document format file converted through the document format conversion portion in the receiver mobile communication terminal; a document embedding viewer generating portion for generating a document embedding viewer by merging the converted merging document format file with the view file; an URL assigning portion for assigning the converted merging document format file to a physical location of an URL (uniform resource locator); a document embedding viewer storing portion for saving the document embedding viewer assigned by the URL assigning portion; and a message transmitting portion for generating a SMS message or a message of a WAP (wireless application protocol) PUSH type having the URL and transmitting it to the receiver mobile communication terminal.

To accomplish the objects, the present invention provides a GSM mobile document transfer system for supporting MIDP environments comprising: a user terminal for writing a document with various document writing program and saving it and connecting to a mobile document receiving server through an internet; the mobile document transmitting server comprising a document receiving portion for receiving an original document made by the user terminal and a receiver information; a document format conversion portion for receiving the document and converting the document into a merging document format file having a font capable of viewing the original document in the receiver mobile communication terminal; a view file generating portion for generating a view file in order to view the merging document format file converted through the document format conversion portion in the receiver mobile communication terminal; a document embedding viewer generating portion for generating a document embedding viewer by merging the converted merging document format file with the view file; an URL assigning portion for assigning the converted merging document format file to a physical location of an URL (uniform resource locator); a document embedding viewer storing portion for saving the docume nt embedding viewer assigned by the URL assigning portion; and a message transmitting portion for generating a SMS message or a message of a WAP (wireless application protocol) PUSH type having the URL and transmitting it to the receiver mobile communication terminal; and the receiver mobile communication terminal for receiving the message having the URL from the mobile document transmitting server, connecting to the URL in order to receive the corresponding document embedding file and displaying it to a receiver.

According to the GSM mobile document transfer system for supporting MIDP environments, the view file is a jar file capable of viewing the document format file in a GSM (Global System for Mobile Communication) mobile communication terminal for supporting the MIDP (Mobile Information Device Profile) environments.

According to the GSM mobile document transfer system for supporting MIDP environments, the document embedding viewer is a jar file capable of viewing the document format file in a GSM (Global System for Mobile Communication) mobile communication terminal for supporting the MIDP (Mobile Information Device Profile) environments.

According to the GSM mobile document transfer system for supporting MIDP environments, the receiver mobile communication terminal is a GSM (Global System for Mobile Communication) mobile communication terminal for supporting the MIDP (Mobile Information Device Profile) environments.

According to the GSM mobile document transfer system for supporting MIDP environments, the merging document format file has a corresponding font used in the converting document (original document) during converting in the merging document format converging portion, whereby it can view it equally with the original document in the receiver mobile communication terminal.

According to the GSM mobile document transfer system for supporting MIDP environments, the mobile document transmitting server further comprises a merging document format file separating portion for generating a document embedding viewer by merging partial front pages of the merging document format file in a case that a size of the merging document format file is more than a predetermined size during the generating of the document embedding viewer and assigning the remaining portion of the merging document format file and the corresponding URL to the view file.

According to the GSM mobile document transfer system for supporting MIDP environments, the view file generating portion of the mobile document transmitting server serves to generate the viewer by assigning the document to the corresponding location of the URL and then, a SMS message or a message of a WAP (wireless application protocol) PUSH type is transmitted to the receiver mobile communication terminal together with the viewer without merging the converted document with the view file, whereby downloading and viewing the document from the first page thereof through the assigned URL.

According to the GSM mobile document transfer system for supporting MIDP environments, the document embedding viewer is automatically installed to the receiver mobile communication terminal and the corresponding document is stored in various applications storage compartments next to the transfer of the corresponding document embedding view file through the corresponding URL connection, whereby reading it at any time.

To accomplish the objects, the present invention provides a transferring method of a GSM mobile document for supporting MIDP environments, comprising the steps of: writing a document with various document writing programs and connecting to a mobile document receiving server through an internet so as to receive the written document; converting the received document into a merging document format file; generating a document embedding viewer by merging the converted merging document format file with a view file capable of viewing it; transmitting a SMS message or a message of a WAP (wireless application protocol) PUSH type having the URL to a receiver mobile communication terminal; connecting to a corresponding URL in the receiver mobile communication terminal; downloading the corresponding document embedding viewer to the receiver mobile communication terminal through the connected URL; and displaying the downloaded document in the receiver mobile communication terminal.

According to the transferring method, the document embedding viewer generating step further comprises a merging document format file separating step for generating a document embedding viewer by merging partial front pages of the merging document format file in a case that a size of the merging document format file is more than a predetermined one and assigning the remaining portion of the merging document format file and the corresponding URL to the view file.

### ADVANTAGEOUS EFFECTS

As can be seen from the foregoing, in the GSM mobile document transfer system for supporting MIDP environments and the transferring method thereof, the documents can be received through the GSM mobile communication terminals for supporting MIDP environments at any time, so that it can view the document in the unspecific GSM mobile communication terminals for supporting MIDP environments without installing separating view programs. Also, the documents can be received through all of the GSM mobile communication terminals, so that various office, image and fax documents, which are transferred by only an E-mail in the prior art, can be directly transmitted to the receiver mobile communication terminal, whereby the user can send and receive the desired document without restrictions on time and place.

### BRIEF DESCRIPTION OF THE DRAWINGS

The above as well as the other objects, features and advantages of the present invention will be more apparent from the following detailed description taken in conjunction with the accompanying drawings, in which:

FIG. 1 is an entire block diagram illustrating a GSM mobile document transfer system for supporting MIDP environments according to one embodiment of the present invention;

FIG. 2 is a block diagram illustrating a mobile document transmitting server of a GSM mobile document transfer system for supporting MIDP environments according to one embodiment of the present invention; and

FIG. 3 is a flow chart illustrating a transferring method of a GSM mobile document for supporting MIDP environments according to one embodiment of the present invention.

### BEST MODE FOR CARRYING OUT THE INVENTION

A preferred embodiment of the invention will be described in detail below with reference to the accompanying drawings.

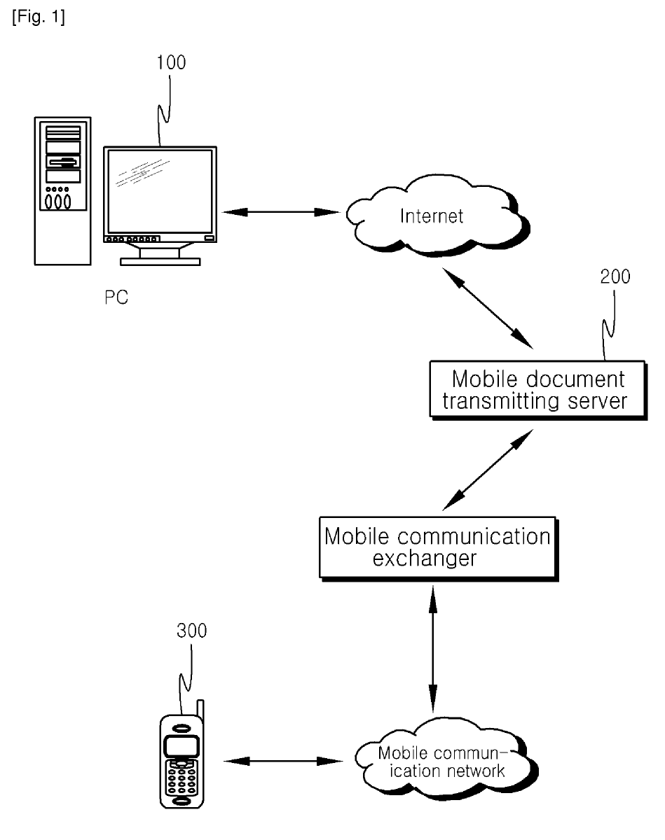

FIG. 1 is an entire block diagram illustrating a GSM mobile document transfer system for supporting MIDP environments according to one embodiment of the present invention.

As shown in FIG. 1, the GSM mobile document transfer system for supporting MIDP environments according to one embodiment of the present invention includes a user terminal 100 for writing a document with various document writing program, saving it and connecting to a mobile document receiving server 200 through an internet; the mobile document transmitting server 200 for receiving an original document made by the user terminal 100 and a receiver information, converting the document into a merging document format file having a font capable of viewing the document format file in the receiver mobile communication terminal, generating a document embedding viewer by merging the converted merging document format file with a view file, saving the document embedding viewer, and transmitting a message including an URL (uniform resource locator) to the receiver mobile communication terminal so as to download the document embedding viewer having the merging document format file; and the receiver mobile communication terminal 300 for receiving the message having the URL from the mobile document transmitting server 200, connecting to the URL in order to receive the corresponding document embedding file and displaying it to a receiver.

Here, the view file may be a jar file capable of viewing the document format file in a GSM (Global System for Mobile Communication) mobile communication terminal for supporting the MIDP (Mobile Information Device Profile) environments.

At this time, the receiver mobile communication terminal may be the GSM (Global System for Mobile Communication) mobile communication terminal for supporting the MIDP (Mobile Information Device Profile) environments.

The merging document format file has a corresponding font used in the converting document (original document) during converting in a merging document format converging portion, so that it can view it equally with the original document in the receiver mobile communication terminal 300.

The GSM mobile document transfer system for supporting MIDP environments according to one embodiment of the present invention includes the user terminal 100, the mobile document transmitting server 200, the receiver mobile communication terminal 300, an Internet, a mobile communication exchanger, and a mobile communication network and so forth.

That is, the user makes out any document in the user terminal 100 and then, logs in the website constituted by the GSM mobile document transfer system for supporting MIDP environments according to one embodiment of the present invention, so that it can be connected to the mobile document transmitting server 200.

Continuously, the mobile document transmitting server 200 serves to receives the original document made by the user terminal 100 and the receiver information, converts the document into the merging document format file having the font capable of viewing the document format file in the receiver mobile communication terminal, generate the document embedding viewer by merging the converted merging document format file with the view file, save the document embedding viewer, and transmit the message including the URL (uniform resource locator) to the receiver mobile communication terminal so as to download the document embedding viewer having the merging document format file.

At this time, the user can check out the message in the receiver mobile communication terminal and connect to the corresponding URL (uniform resource locator) so as to download the document embedding viewer, so that it can directly view the document without installing a separating document viewer.

Preferably, the user can download the programs on-line in the receiver mobile communication terminal and use various programs off-line through a mobile phone, thereby presenting total solutions of the wireless Internet.

More concretely, the user can download the programs on-line through a Http (HyperText Transfer Protocol) or a WAP (Wireless Application Protocol) and then, use the downloaded programs off-line through the mobile phone. On this account, the receiver mobile communication terminal utilizes the GSM (Global System for Mobile Communication) mobile communication terminal for supporting the MIDP (Mobile Information Device Profile) environments developed by a SUN Microsytems, so that the user can download and use the desired information and so forth through the wireless Internet without restrictions on time and place.

The GSM mobile document transfer system for supporting MIDP environments according to the present invention utilizes the merging document format capable of viewing the document through the GSM (Global System for Mobile Communication) mobile communication terminal. Here, preferably it is based on a CSD, SVG (Scalable Vector Graphics) or PDF and so on as the merging document format by utilizing a recorded medium capable of reading through a computer of recording a program having a document embedding view function and a method thereof disclosed in Korean patent registration No. 0603984 filed by the present applicant in 2004.

The CSD format includes application levels having an engine capable of rendering a graphic and a font and codes on basic user interfaces and document data levels having the contents of the corresponding document, and font data, graphic data, location information, and color information thereof, and code and location information of each word. Here, since these techniques are already widely well-known, further description on these is omitted here.

The characteristics of the document format file filed and registered by the present applicant will be described in brief below.

That is, in the document format file according to the present invention, the converting speed of the general electric document having his font, the inquiry speed are fast and the document, which is converted through an image overlapping cancellation by using an image compression, a document code information compression and a pattern matching, is smaller than the original document, thereby it can easily and rapidly be used in the receiver mobile communication terminal subject to restriction on the data transfer and saving.

Also, the mobile document transmitting server 200 serves to generate the document embedding viewer by merging the converted merging document format file with the view file capable of viewing the document format file.

That is, the merging document format file is merged with the jar file as a view code, so that it can generate the document embedding viewer.

Here, preferably, the view file may be the jar file capable of viewing the document format file in a GSM (Global System for Mobile Communication) mobile communication terminal for supporting the MIDP (Mobile Information Device Profile) environments.

In a user's situation of the GSM (Global System for Mobile Communication) environments, where a messaging PUSH of a WAP PUSH type is transmitted to the receiver mobile communication terminal, it can connect to the corresponding URL, thereby downloading the document embedding viewer including the jar file.

Here, the jar file can be installed as an application such as game software and so on in the receiver mobile communication terminal. In this case, the jar file can be automatically installed next to the downloading thereof and the document can be stored in various applications storage compartments so as to read it at any time.

Accordingly, the document embedding viewer generated by merging the merging document format file having the font with the view file serves to view any document regardless of the word processing programs, differently with the conventional viewers for supporting only the restricted word processing programs. Also, it can directly view the document through the transferred document embedding viewer simultaneously with the connection with the corresponding URL without installing a separating document viewer beforehand.

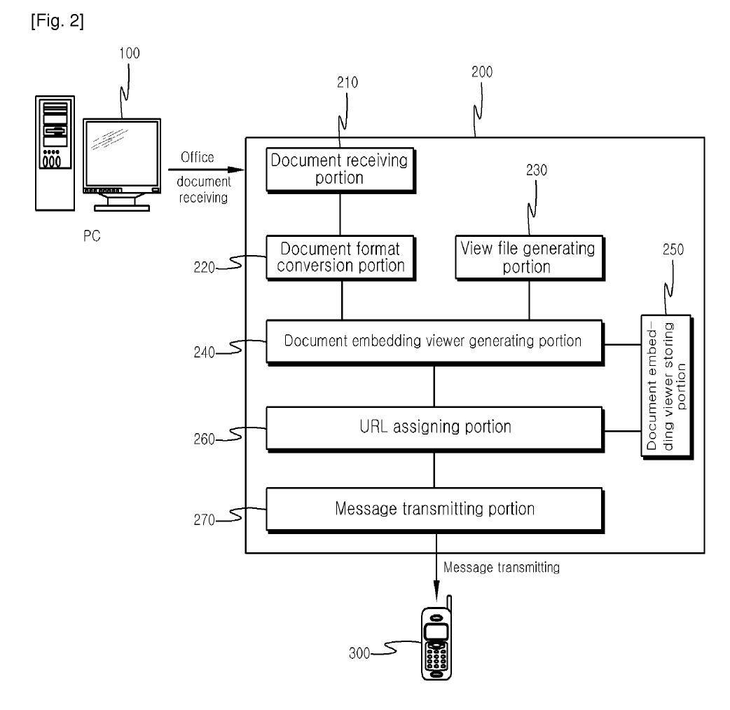

FIG. 2 is a block diagram illustrating a mobile document transmitting server of a GSM mobile document transfer system for supporting MIDP environments according to one embodiment of the present invention.

As shown in FIG. 2, the mobile document transmitting server 200 according to the present invention includes a document receiving portion 210 for receiving an original document made by the user terminal 100 and a receiver information; a document format conversion portion 220 for receiving the document and converting the document into a merging document format file having a font capable of viewing the original document in the receiver mobile communication terminal; a view file generating portion 230 for generating a view file in order to view the merging document format file converted through the document format conversion portion 220 in the receiver mobile communication terminal; a document embedding viewer generating portion 240 for generating a document embedding viewer by merging the converted merging document format file with the view file; an URL assigning portion 260 for assigning the converted merging document format file to a physical location of an URL (uniform resource locator); a document embedding viewer storing portion 250 for saving the document embedding viewer assigned by the URL assigning portion 260; and a message transmitting portion 270 for generating a SMS message or a message of a WAP (wireless application protocol) PUSH type having the URL and transmitting it to the receiver mobile communication terminal.

The merging document format file has a corresponding font used in the converting document (original document) during converting in the merging document format converging portion 220, so that it can view it equally with the original document in the receiver mobile communication terminal 300.

That is, the converted merging document format file is merged with the view file and the document embedding viewer is generated by the document embedding viewer generating portion 240, so that the merging document format file has the corresponding font used in the converting document (original document) during converting in the merging document format converging portion 220, thereby it can view it equally with the original document in the receiver mobile communication terminal 300.

Also, the mobile document transmitting server 200 according to another embodiment of the present invention further includes a merging document format file separating portion (not shown) for generating a document embedding viewer by merging partial front pages of the merging document format file with the view file in a case that a size of the merging document format file is more than a predetermined one during the generating of the document embedding viewer and assigning the remaining portion of the merging document format file and the corresponding URL to the view file.

In the mobile document transmitting server 200 according to further another embodiment of the present invention, the view file generating portion 230 serves to generate the viewer by assigning the document to the corresponding location of the URL and then, a SMS message or a message of a WAP (wireless application protocol) PUSH type is transmitted to the receiver mobile communication terminal together with the viewer without merging the converted document with the view file, whereby downloading and viewing the document from the first page thereof through the assigned URL.

That is, the URL of the merging document format file is assigned to the viewer in the view file generating portion 230, thereby performing the above function.

In other words, where the size of the office document is very larger, since the size of the document embedding viewer becomes larger, it can be restricted in the install of the application. In this case, the partial front pages of the document are merged with the document embedding viewer and the URL of the remaining portion of the document is assigned to the jar file, so that it can be connected to the corresponding URL through the mobile communication network and download the remaining document existed in the corresponding URL where the user clicks the following page while viewing the document of the application type.

Here, the server's administrator can assign the basic size of the document in advance, so that it can separate the document through the merging document format file separating portion (not shown) in case of exceeding the basic size thereof.

The document receiving portion 210 for receiving the original document made by the user terminal 100 and the receiver information can receive a user identification information for identifying the users together with the original document made by the user through an interface portion (not shown) of the user terminal 100.

The general structure of the information data includes a data portion and a head portion having a size of each data field, a size of the entire data packets, identification information on a compression manner of the corresponding data field and a data construction, and other identification information for identifying the data transmitter. Here, the user identification information further includes a telephone number.

Also, the head portion of the information data further includes a telephone number.

The document embedding viewer storing portion 250 for saving the document embedding viewer assigned by the URL assigning portion 260 can save the telephone numbers of the receivers at the same time, check out the corresponding URL, and sort the connecting receivers so as to match each office document with the corresponding receiver.

Here, since the techniques for identifying each receiver information and matching each office document with the corresponding receiver are already widely well-known, further description on these is omitted here.

That is, in the document format conversion portion 220, the original document is converted into the merging document format file having the font capable of viewing the original document in the receiver mobile communication terminal and the converted merging document format file is merged with the view file to generate the document embedding viewer. Then, the completed document embedding viewer is transmitted to the receiver mobile communication terminal 300, so that it can directly view the document simultaneously with the receiving without installing a separating document viewer.

Accordingly, it can solve the conventional problems, in that the office documents besides images or movies cannot be viewed in the receiver mobile communication terminal.

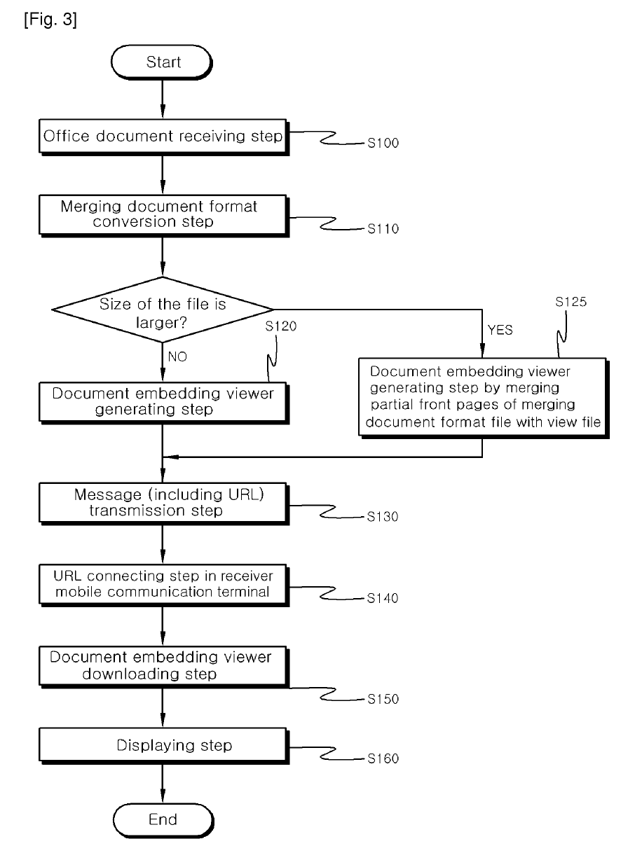

The operation method of the GSM mobile document transfer system for supporting MIDP environments according to the present invention will be described in detail below with reference to FIG. 3.

FIG. 3 is a flow chart illustrating a transferring method of a GSM mobile document for supporting MIDP environments according to one embodiment of the present invention.

As shown in FIG. 3, the transferring method of the GSM mobile document for supporting MIDP environments according to the present invention includes a document receiving step S100 for writing a document with various document writing programs and connecting to a mobile document receiving server 200 through an internet so as to receive the written document; a merging document format conversion step S110 for converting the received document into a merging document format file; a document embedding viewer generating step 120 for generating a document embedding viewer by merging the converted merging document format file with a view file capable of viewing it; a message transmission step S130 for transmitting a SMS message or a message of a WAP (wireless application protocol) PUSH type having the URL to a receiver mobile communication terminal 300; an URL (uniform resource locator) connecting step S140 for connecting to a corresponding URL in the receiver mobile communication terminal 300; a document embedding viewer downloading step 150 for downloading the corresponding document embedding viewer to the receiver mobile communication terminal 300 through the connected URL; and a displaying step S160 for displaying the downloaded document in the receiver mobile communication terminal 300.

The document embedding viewer generating step 120 further includes a merging document format file separating step for generating a document embedding viewer by merging partial front pages of the merging document format file with a view file in a case that a size of the merging document format file is more than a predetermined one and assigning the remaining portion of the merging document format file and the corresponding URL to the view file.

More concretely, where the documents are written through various document writing programs of the user's terminal and it is connected to the mobile document transmitting server 200 through the Internet (S100), the mobile document transmitting server 200 serves to receives the original document made by the user terminal 100 and the receiver information and converts the document into the merging document format file having the font capable of viewing the document format file in the receiver mobile communication terminal (S110). Continuously, it generates the document embedding viewer through the document embedding viewer generating portion 240 by merging the merging document format file converted by the document format conversion portion 220 with the view file (S120).

Here, only the partial front pages of the merging document format file are merged with the view file so as to generate the document embedding viewer in a case that a size of the merging document format file is larger than a predetermined one (for example, the basic size assigned by the server's administrator is 10 Megabytes) during the generating of the document embedding viewer (S125). Also, the remaining portion of the merging document format file and the corresponding URL are assigned to the view file, so that the receiver can checked out it first.

Continuously, the SMS message or a message of a WAP (wireless application protocol) PUSH type having the URL is generated and then, transmitted to the receiver mobile communication terminal 300 (S130).

When the receiver of receiving the message is connected to the corresponding URL through the receiver mobile communication terminal 300, the corresponding document embedding viewer is transmitted to the corresponding mobile communication terminal 300 through the document embedding viewer storing portion 250, so that it can download the corresponding document embedding viewer to the receiver mobile communication terminal 300 (S150), thereby displaying the downloaded document in the receiver mobile communication terminal 300 (S160).

As can be seen from the foregoing, in the GSM mobile document transfer system for supporting MIDP environments and the transferring method thereof, the user can send and receive the desired document without restrictions on time and place and various office, image and fax documents, which are transferred by only an E-mail in the prior art, can be directly transmitted to the receiver mobile communication terminal.

While this invention has been described in connection with what are presently considered to be the most practical and preferred embodiments, it is to be understood that the invention is not limited to the disclosed embodiments and the drawings, but, on the contrary, it is intended to cover various modifications and variations within the spirit and scope of the appended claims.

### INDUSTRIAL APPLICABILITY

The present invention relates to a GSM mobile document transfer system for supporting MIDP environments and a transferring method thereof, in that a MS office document or another office document are transferred to a mobile communication terminal through a web to phone manner, whereby it can receive and view the office and image documents in general GSM mobile communication terminal at any time without installing a separating document viewer beforehand.

1. A GSM mobile document transfer system for supporting MIDP environments comprising:
a user terminal for writing a document with various document writing program, saving it and connecting to a mobile document receiving server through an internet;
the mobile document transmitting server for receiving an original document made by the user terminal and a receiver information, converting the document into a merging document format file having a font capable of viewing the document format file in a receiver mobile communication terminal, generating a document embedding viewer by merging the converted merging document format file with a view file, saving the document embedding viewer, and transmitting a message including an URL (uniform resource locator) to the receiver mobile communication terminal so as to download the document embedding viewer having the merged document format file; and
the receiver mobile communication terminal for receiving the message having the URL from the mobile document transmitting server, connecting to the URL in order to receive the corresponding document embedding file and displaying it to a receiver.

2. A GSM mobile document transfer system for supporting MIDP environments as claimed in claim 1, wherein the mobile document transmitting server comprises:
a document receiving portion for receiving an original document made by the user terminal and a receiver information;
a document format conversion portion for receiving the document and converting the document into a merging document format file having a font capable of viewing the original document in the receiver mobile communication terminal;
a view file generating portion for generating a view file in order to view the merging document format file converted through the document format conversion portion in the receiver mobile communication terminal;
a document embedding viewer generating portion for generating a document embedding viewer by merging the converted merging document format file with the view file;
an URL assigning portion for assigning the converted merging document format file to a physical location of an URL (uniform resource locator);
a document embedding viewer storing portion for saving the document embedding viewer assigned by the URL assigning portion; and
a message transmitting portion for generating a SMS message or a message of a WAP (wireless application protocol) PUSH type having the URL and transmitting it to the receiver mobile communication terminal.

3. A GSM mobile document transfer system for supporting MIDP environments comprising:
a user terminal for writing a document with various document writing program, saving it and connecting to a mobile document receiving server through an internet;
the mobile document transmitting server comprising a document receiving portion for receiving an original document made by the user terminal and a receiver information; a document format conversion portion for receiving the document and converting the document into a merging document format file having a font capable of viewing the original document in the receiver mobile communication terminal; a view file generating portion for generating a view file in order to view the merging document format file converted through the document format conversion portion in a receiver mobile communication terminal; a document embedding viewer generating portion for generating a document embedding viewer by merging the converted merging document format file with the view file; an URL assigning portion for assigning the converted merging document format file to a physical location of an URL (uniform resource locator); a document embedding viewer storing portion for saving the document embedding viewer assigned by the URL assigning portion;
and a message transmitting portion for generating a SMS message or a message of a WAP (wireless application protocol) PUSH type having the URL and transmitting it to the receiver mobile communication terminal; and
the receiver mobile communication terminal for receiving the message having the URL from the mobile document transmitting server, connecting to the URL in order to receive the corresponding document embedding file and displaying it to a receiver.

4. A GSM mobile document transfer system for supporting MIDP environments as claimed in claim 1 or 3, wherein the view file is a jar file capable of viewing the document format file in a GSM (Global System for Mobile Communication) mobile communication terminal for supporting the MIDP (Mobile Information Device Profile) environments.

5. A GSM mobile document transfer system for supporting MIDP environments as claimed in claim 1 or 3, wherein the document embedding viewer is a jar file capable of viewing the document format file in a GSM (Global System for Mobile Communication) mobile communication terminal for supporting the MIDP (Mobile Information Device Profile) environments.

6. A GSM mobile document transfer system for supporting MIDP environments as claimed in claim 1 or 3, wherein the receiver mobile communication terminal is a GSM (Global System for Mobile Communication) mobile communication terminal for supporting the MIDP (Mobile Information Device Profile) environments.

7. A GSM mobile document transfer system for supporting MIDP environments as claimed in claim 1 or 3, wherein the merging document format file has a corresponding font used in the converting document (original document) during converting in the merging document format converging portion, whereby it can view it equally with the original document in the receiver mobile communication terminal.

8. A GSM mobile document transfer system for supporting MIDP environments as claimed in claim 1 or 3, wherein the mobile document transmitting server further comprises a merging document format file separating portion for generating a document embedding viewer by merging partial front pages of the merging document format file with the view file in a case that a size of the merging document format file is more than a predetermined size during the generating of the document embedding viewer and assigning the remaining portion of the merging document format file and the corresponding URL to the view file.

9. A GSM mobile document transfer system for supporting MIDP environments as claimed in claim 1 or 3, wherein the view file generating portion of the mobile document transmitting server serves to generate the viewer by assigning the document to the corresponding location of the URL and then, a SMS message or a message of a WAP (wireless application protocol) PUSH type is transmitted to the receiver mobile communication terminal together with the viewer without merging the converted document with the view file, whereby downloading and viewing the document from the first page thereof through the assigned URL.

10. A GSM mobile document transfer system for supporting MIDP environments as claimed in claim 1 or 3, wherein the document embedding viewer is automatically installed to the receiver mobile communication terminal and the corresponding document is stored in various applications storage compartments next to the transfer of the corresponding document embedding view file through the corresponding URL connection, whereby reading it at any time.

11. A transferring method of a GSM mobile document for supporting MIDP environments, comprising the steps of:
writing a document with various document writing programs and connecting to a mobile document receiving server through an internet so as to receive the written document;
converting the received document into a merging document format file;
generating a document embedding viewer by merging the converted merging document format file with a view file capable of viewing it;
transmitting a SMS message or a message of a WAP (wireless application protocol) PUSH type having the URL to a receiver mobile communication terminal;
connecting to a corresponding URL in a receiver mobile communication terminal;
downloading the corresponding document embedding viewer to the receiver mobile communication terminal through the connected URL; and
displaying the downloaded document in the receiver mobile communication terminal.

12. A transferring method in claim 11, wherein the document embedding viewer generating step further comprises a merging document format file separating step for generating a document embedding viewer by merging partial front pages of the merging document format file with the view file and assigning the remaining portion of the merging document format file and the corresponding URL to the view file in a case that a size of the merging document format file is more than a predetermined size.
